(19) United States
(12) Patent Application Publication
(10) Pub. No.: US 2013/0163565 A1
(43) Pub. Date: Jun. 27, 2013

(54) METHOD FOR COMMUNICATION BASED ON MOBILE ACCESS POINT IN RADIO COMMUNICATION SYSTEM AND APPARATUS FOR THE SAME

(71) Applicants: IL GU LEE, Gwangmyeong-si (KR); Sok Kyu Lee, Daejeon-si (KR)

(72) Inventors: IL GU LEE, Gwangmyeong-si (KR); Sok Kyu Lee, Daejeon-si (KR)

(73) Assignee: Electronics and Telecommunications Research Institute, Daejeon (KR)

(21) Appl. No.: 13/615,454

(22) Filed: Sep. 13, 2012

(30) Foreign Application Priority Data
Dec. 23, 2011 (KR) 10-2011-0141079

(51) Int. Cl. H04W 36/32; H04W 36/30

(52) U.S. Cl. 370/332

(57) ABSTRACT

A communication method based on an access point (AP) in a radio communication system is provided. The method includes: acquiring positional information regarding at least one station (STA) and at least one adjacent AP; acquiring interference information from the at least one adjacent AP; determining whether to move based on the positional information and the interference information; determining a position to move based on the positional information and the interference information when determining to move; moving to the position to move; and providing communication services to a subscribed STA at the position.

### CROSS-REFERENCE TO RELATED APPLICATIONS

This application claims the benefit of priority of Korean Patent Application No. 10-2011-0141079 filed on Dec. 23, 2011, which is incorporated by reference in their entirety herein.

### BACKGROUND OF THE INVENTION

1. Field of the Invention

The present invention relates to radio communication, and more particularly, to a communication method based on a mobile access point (AP) in a radio communication system and an apparatus for supporting the same.

2. Related Art

Various radio communication technologies, such as a wireless local area network (WLAN), mobile communication, or the like, have been developed. Recently, one terminal includes a module capable of supporting a plurality of radio communication technologies and a user can receive various communication services through one terminal

All the radio communications receive and transmit information and data between a sender and a receiver and a user at a terminal side may be connected with a targeted terminal with which he/she wants to communicate through a relay station to perform communication.

For example, a user using cellular mobile communication may perform communication through a base station (BS). In addition, a user using the WLAN can perform communication through an access point (AP).

The user generally has mobility and uses mobile communication services and a relay station such as BS and AP is fixed. In an area in which there is no relay station, services may not be provided. The user wishing to receive communication services searches a relay station and directly moves to an area in which there is a relay station and accesses a relay station in the area to receive a service. That is, concentration of mobile communication service users is changed from moment to moment and service coverage is fixed, which may cause inefficiency of communication.

Meanwhile, characteristics associated with the coverage of the relay station and installation of the relay station are limited due to frequency regulation, coexistence between heterogeneous communication systems, and/or economical efficiency. As a result, the service coverage cannot unconditionally extend realistically. Therefore, a need exists for an improved communication method capable of providing services to a user as maximally as possible while solving the above-mentioned problems.

### SUMMARY OF THE INVENTION

The present invention has been made in an effort to provide communication method and apparatus based on an access point (AP) supporting mobility in a radio communication system.

In an aspect, a communication method based on an access point (AP) in a radio communication system is provided. The method includes: acquiring positional information regarding at least one station (STA) and at least one adjacent AP; acquiring interference information from the at least one adjacent AP; determining whether to move based on the positional information and the interference information; determining a position to move based on the positional information and the interference information when determining to move; moving to the position to move; and providing communication services to a subscribed STA at the position.

The step of determining whether to move may include determining whether STA positioned outside of current service coverage of the AP is present, and if it is determined that the STA positioned outside of the current service coverage is present, determining to move.

The position to move may be determined so that the STA positioned outside of the current service coverage is positioned within a new service coverage based on the position.

The interference information may include information indicating the service coverage of the at least one adjacent AP.

The position to move may be determined so as to minimize an area in which the new service coverage overlaps the service coverage of the at least one adjacent AP based on the position to move.

The positional information may be received via a global positioning system (GPS).

The step of moving may be performed to move to the position by an unmanned mobile body.

The unmanned mobile body may be an unmanned aerial vehicle (UAV).

The communication service provided to the subscribed STA may be a wireless local area network (WLAN).

In another aspect, a radio apparatus is provided. The apparatus includes: a communication module that transmits and receives radio signals; a control unit that is operated by being functionally coupled with the communication module; and a mobile unit that moves when receiving a moving command from the control unit. The communication module is configured to: receive positional information regarding at least one station (STA) and at least one adjacent access point (AP), and receive interference information from the at least one adjacent AP. The control unit is configured to: determines whether to move based on the positional information and the interference information, determines a position to move based on the positional information and the interference information when determining to move, and transmit a moving command including information regarding the position to move to the mobile unit. The mobile unit moves the radio apparatus to the position to move.

The determining whether to move may include determining whether STA positioned outside of current service coverage of the radio apparatus is present, and if it is determined that the STA positioned outside of the current service coverage is present, determining to move.

The position to move may be determined so that the STA positioned outside of the current service coverage is positioned within new service coverage based on the position.

The interference information may include information indicating the service coverage of the at least one AP.

The position to move may be determined so as to minimize an area in which the new service coverage of the AP overlaps the service coverage of the at least one adjacent AP based on the position to move.

The position information may be received via a global positioning system (GPS).

The mobile unit may include a moving unit driving unit; and an automatic navigation device. The automatic navigation device may perform a moving control based on information regarding the position to move, and the moving unit driving unit may move the radio apparatus according to the moving control.

The moving unit driving unit may include a moving unit based on an unmanned mobile body. The moving to the position to move may be performed by the moving unit based on the unmanned mobile body.

The unmanned mobile body may be an unmanned aerial vehicle (UAV).

The radio apparatus may further includes an input/output unit. The input/output unit may include at least one sensor for recognizing external environment of the radio apparatus.

The control unit may include communication services to a subscribed STA at the position to move.

The communication service may be a wireless local area network (WLAN).

### BRIEF DESCRIPTION OF THE DRAWINGS

FIG. 1 is a diagram showing an example of a configuration of a wireless LAN system to which an exemplary embodiment of the present invention is applied.

FIG. 2 is a diagram showing an example of the configuration of the wireless LAN system to which a communication method in accordance with another exemplary embodiment of the present invention is applied.

FIG. 3 is a flow chart of the communication method in accordance with the exemplary embodiment of the present invention.

FIG. 4 is a diagram showing a mobile AP and a network implementing the exemplary embodiment of the present invention.

FIG. 5 is a diagram showing an example of environment to which the exemplary embodiment of the present is applied.

FIG. 6 is a diagram showing an example to which the exemplary embodiment of the present invention is applied in a communication system based on a TV white space band.

### DESCRIPTION OF EXEMPLARY EMBODIMENTS

Hereinafter, embodiments of the present invention will be described in detail with reference to the accompanying drawings so that those skilled in the art may easily practice the present invention. However, the present invention may be modified in various different ways and is not limited to the embodiments provided in the present description. In the accompanying drawings, portions unrelated to the description will be omitted in order to obviously describe the present invention, and similar reference numerals will be used to describe similar portions throughout the present specification.

Unless explicitly described to the contrary, the term “comprise” and variations such as “comprises” or “comprising” will be understood to imply the inclusion of stated elements but not the exclusion of any other elements. A term “module” described in the specification means a single unit of processing a predetermined function or operation and can be implemented by hardware or software or a combination of hardware and software.

Hereinafter, exemplary embodiments of the present invention will be described a communication system (wireless LAN system) supporting a wireless local area network (WLAN) by way of example. However, a scope of the present invention is not limited only to the WLAN and therefore, may be applied to a general radio communication system and a radio communication system in which a single mobile communication system and a plurality of communication systems coexist.

The WLAN system to which the exemplary embodiments of the present invention can be applied includes one or more basic service set (BSS). The BSS is a set of stations (STA) that are successfully synchronized with one another to communicate with one another and is not limited to a concept indicating a specific area.

The STA means any functional medium that includes a medium access control (MAC) according to regulations of Institute of Electrical and Electronics Engineers (IEEE) 802.11 standard and a physical layer interface for a wireless medium and includes both of AP and non-AP stations in a broad sense.

The non-AP STA is an STA rather than the AP. The non-AP STA may be referred to as a mobile terminal, a wireless device, a wireless transmit/receive unit (WTRU), user equipment (UE), a mobile station (MS), or a mobile subscriber unit, or simply other names such as user. Hereinafter, the non-AP STA is referred to as the STA for convenience of explanation.

The AP is a functional entity for accessing a DS via a wireless medium for the STA associated with the corresponding AP In an infrastructure BSS including the AP, the communication among the STAs is basically performed via the AP but the STAs directly communicate with one another when a direct link is set. The AP may be referred to as a central controller, a base station (BS), a node-B, a base transceiver system (BTS), a site controller, or the like.

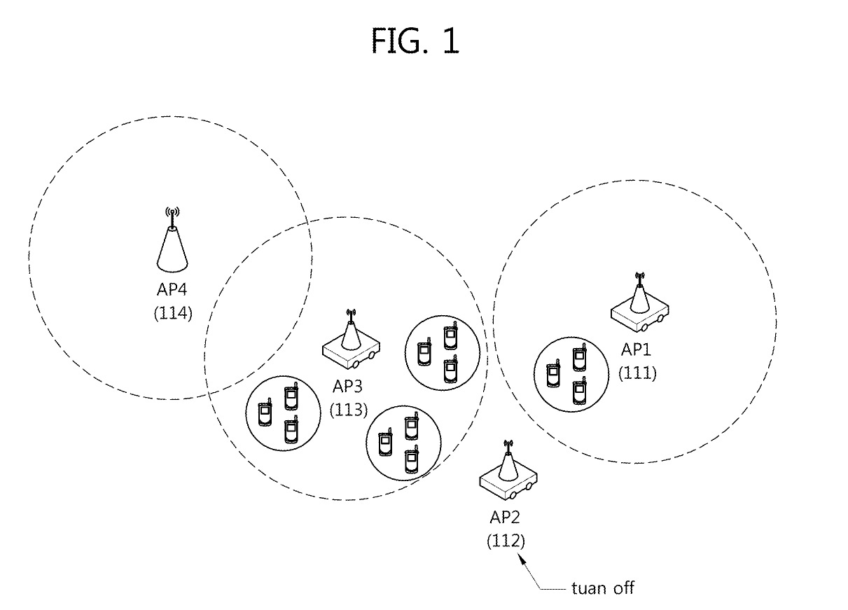

FIG. 1 is a diagram showing an example of a configuration of a wireless LAN system to which an exemplary embodiment of the present invention can be applied.

Referring to FIG. 1, a WLAN system includes both of a fixed AP and a mobile AP. An AP1 111, an AP2 112, and an AP3 113, which are a mobile AP, include a function of the AP of the above-mentioned WLAN system and include a movable unit. An AP4 114, which is a fixed AP, includes a function of the AP but does not include the movable unit. The AP1 111, the AP2 112, and the AP3 113 maintain independent coverage for providing services. The service coverages of each AP are shown by a dotted line.

The STAs are associated with the specific AP to receive services. The STAs are densely positioned in the specific area. Each STA, which is a user terminal, has mobility.

As shown in FIG. 1, a larger number of STAs than the number of STAs positioned in another AP coverage are positioned within the service coverage based on the AP3 113. In the WLAN, the STAs perform a competition based medium access and thus, as the more the number of STAs within the coverage, it may difficult to exchange frames among the APs. That is, the AP3 113 may cause overload of services due to an excessive concentration of the STAs.

Further, as the STAs move, the STAs may be out of the service coverage. When the mobile AP is not included in the WLAN system, the overall service coverage is not changed without controlling transmission power of the AP. Therefore, when the STA moves, the STA cannot continuously provide services.

Therefore, the exemplary embodiment of the present invention provides a communication method capable of solving problems such as service stop due to the high concentration of the STAs and the mobility of the STAs based on the mobile AP.

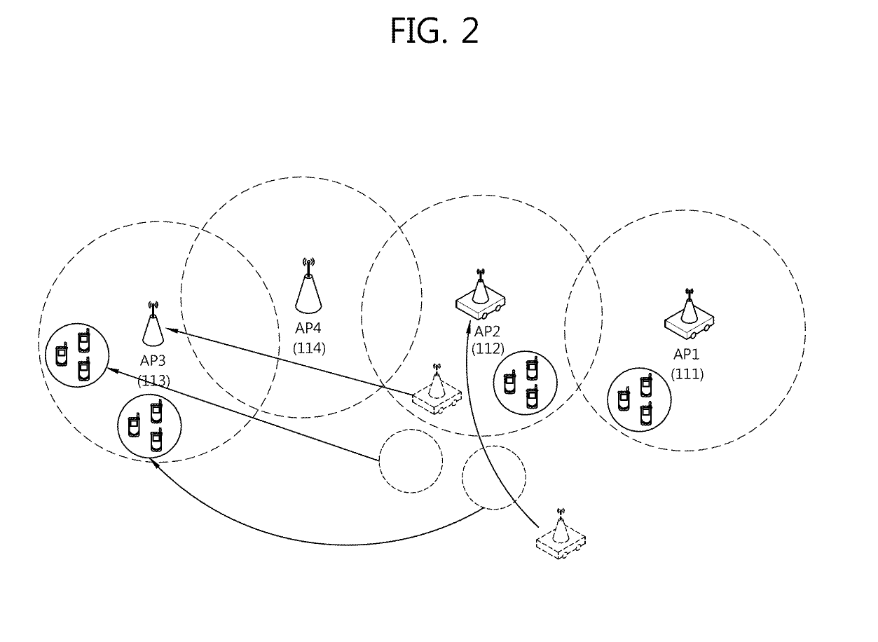

FIG. 2 is a diagram showing an example of the configuration of the wireless LAN system to which a communication method in accordance with another exemplary embodiment of the present invention is applied.

Referring to FIG. 2, two STA groups associated with the AP3 113 move. Referring to the position of the STAs after the movement thereof, it can be appreciated that the STAs is out of the service coverage that are originally configured. Therefore, when the service coverage is not changed, two STA groups cannot receive services any more.

To this end, the AP3 113 moves to continuously provide services to two moving STA groups, thereby configuring new service coverage. After the movement, the STA group is positioned within the service coverage of the AP3 113 to continuously receive the WLAN services.

On the other hand, when the AP3 113 moves, the STA groups that do not move are out of the service coverage. Therefore, the AP2 112 that does not provide services moves to the specific position to initiate services, such that the corresponding STA group can continuously provide the WLAN services.

As shown in FIG. 2, when the service coverage is changed via the mobile AP, services can be continuously provided to the STA having mobility.

In FIG. 1, the STAs are excessively concentrated within the coverage of the AP3 113. On the other hand, it can be appreciated from FIG. 2 that the corresponding STAs are separately associated with the coverage of the AP2 112 and the coverage of the AP3 113. Therefore, the excessive concentration of the STAs may be distributed to improve the overall throughput of the WLAN system.

In addition, it can be appreciated that the position of the AP3 113 before the movement and the position of the AP2 112 after the movement are slightly different. This is to minimize the overlapping area with the service coverage of another AP while continuously providing services to the STA groups that receive the WLAN services from the AP3 113. When the service coverages overlap each other, it is highly like to cause the mutual interference.

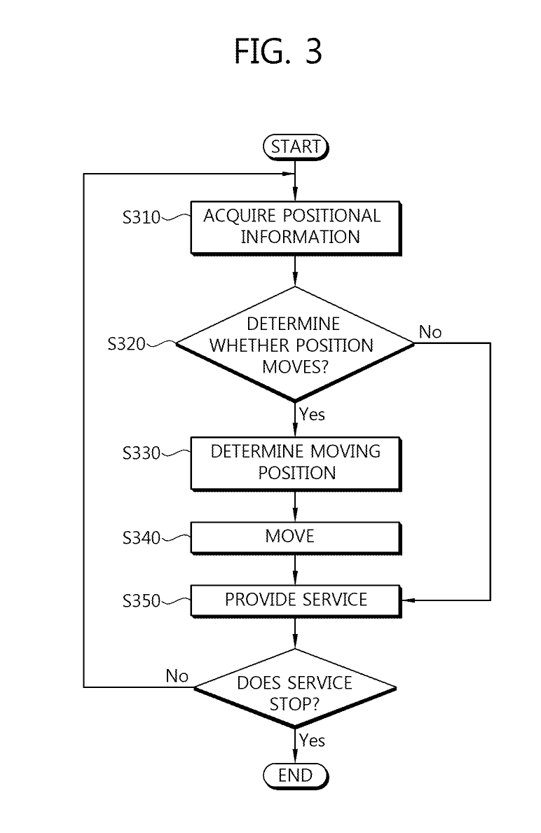

The communication method in accordance with the exemplary embodiment of the present invention will be described with reference to FIG. 3.

FIG. 3 is a flow chart of the communication method in accordance with the exemplary embodiment of the present invention.

Referring to FIG. 3, the AP acquires the positional information (S310). The AP and/or the STA supporting the WLAN may generally support the heterogeneous communication system. That is, the AP and/or the STA may support mobile communication, GPS, or the like. The AP and/or the STA acquire the positional information of another AP and/or the STA based on supportable communication units.

In addition, the AP can acquire the interference information from other adjacent APs and/or STAs. The interference information, which is information regarding the interference due to the distribution of the service coverage, may include the information indicating the service coverage of each AP.

The AP determines whether the AP moves based on the positional information and/or the interference information of another AP and/or STA. The AP acquires the positional information at S310. In addition, the AP may acquire the interference information. The AP can appreciate the concentration of the STAs, the distribution of the APs, and the coverages formed by each AP, or the like, based on the positional information and the interference information. Therefore, the APs may determine whether the AP moves based on the service coverage condition of each AP. In more detail, the APs determine whether the STAs are out of the overall service coverage of the WLAN and may be determined as being moved when the corresponding STAs are present.

The AP may provide service at a current position if it is determined that the AP is not moved.

The AP determines a position to move if it determined that the AP moves (S330). The moving position of the AP may be determined to satisfy at least one of a condition that the STAs out of the conventional service coverage are provided with services within a new service coverage, a condition that the condensation of the STAs is reduced, and a condition that the service coverages among the APs does not overlap each other.

The AP moves to the determined moving position (S340) and provides the WLAN services to the STAs within a new service coverage (S350).

When the service of the AP does not stop, S310 to S350 may be periodically repeated.

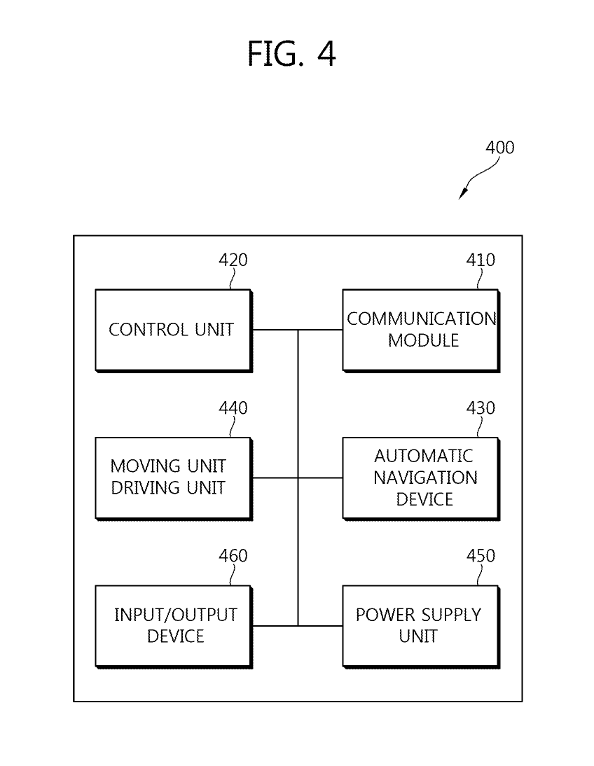

FIG. 4 is a diagram showing a mobile AP and a network implementing the exemplary embodiment of the present invention.

Referring to FIG. 4, the mobile AP 400 includes a communication module 410, a control unit 420, an automatic navigation device 430, a moving unit driving unit 440, a power supply unit 450, and an input/output device 460.

The communication module 410 may be set to support at least one communication service. The communication module 410 may be set to receive the WLAN services, the mobile communication services, satellite communication services, and short range communication services. The communication module 410 includes at least radio frequency (RF) unit such as at least antenna. The RF unit transmits and receives radio signals according to the communication services that can be supported by the communication module. For example, the RF unit may transmit and receive the radio signals associated with the positional information via the GPS, transmit and receive the position/interference information from and to adjacent APs and STAs through the WLAN, and transmit and receive signals from and to the mobile communication terminal

The positional information received from the GPS may include the positional information of the mobile AP and the positional information of the STA. The positional information may also include the positional information of other mobile APs and the positional information of the fixed AP.

The control unit 420 controls the general operation of the above-mentioned mobile AP 400. The control unit 420 determines whether the mobile AP 400 moves based on the positional information/interference information transmitted from the communication module 410 and determines the moving position determined to move. The control unit 420 transmits the information associated with the moving position to the automatic navigation device 430. The control unit 420 transmits the information associated with the moving information/interference information/moving position to the input/output device 460, which may be in turn output.

The automatic navigation device 430 controls the moving direction and distance of the mobile AP 410 according to the movement or not/movement position determined in the control unit 410 and derives the moving unit driving unit 440.

The moving unit driving unit 440 may be a driving device that can move the fixed AP 400. A type of the driving device may not be particularly limited.

The power supply unit 450 controls power of each component of the mobile AP 400.

The input and output device 460 includes an input unit that receives signals from a camera and sensors and an output unit that monitors the input signals. The input and output device may include sensors that can recognize external environment. For example, the input and output device may include an obstacle sensing sensor for recognizing proximity obstacles during the movement, a gravity sensor for maintaining a balance of a mobile body, a directional sensor serving as a compass, or the like.

The moving unit may use land, sea, and air. In the case of the land, as the moving unit, a wheel may be used, in the case of the sea/undersea, as the moving unit, a ship or a submarine may be used, and in the case of the air, as the moving unit, a propeller, a wing, a balloon may be used. In the exemplary embodiment of the present invention, an unmanned aerial vehicle (UAV) will be described below. The UAV mounts a camera, a sensor, communication devices, or other devices and is an aerial vehicle that is remotely controlled or operated for oneself.

The exemplary embodiment of the present invention minimizes a generation of an overlapped basic service set (OBSS), thereby making it possible to improve the performance of the network and reduce the power consumption of the APs and/or the STAs.

The mobile AP may minimize the interference by measuring signal receiving intensity of the APs belonging to the adjacent service areas or receiving the signals from the STAs belonging to the OBSS and may move to a position at which the overall service coverage may be maximized so as not to overlap the service coverages among the APs.

The mobile AP may be operated by entering a power save mode when the operation is unnecessary. In this case, the mobile AP may be operated by periodically receiving and confirming a service request message of the STA.

The mobile AP automatically moves to the closest charging station before the duration of the power supply unit lapses and is charged. Then, the mobile AP performs its own function. This technology is similar to an automatic battery charging technology that is applied to a cleaning robot. The mobile body may be used as an unmanned aerial vehicle type or an unmanned robot type. The mobile body circulates a moving path according to a given algorithm and changes its own position according to the algorithm. The algorithm determines the movement or not/the moving position based on the positional information.

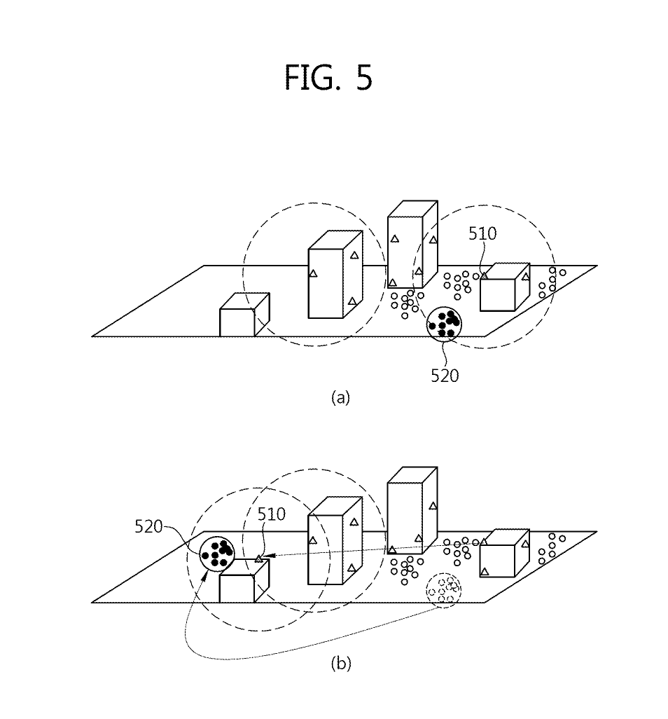

FIG. 5 is a diagram showing an example of environment to which the exemplary embodiment of the present is applied. FIG. 5 shows a self organization of the mobile AP in accordance with the concentration of the user terminals. In FIG. 5, a dark triangle represents the mobile AP and a white triangle represents the fixed AP. Small circles that are concentrated represents the user terminal.

FIG. 5A shows the environment before the group of the user terminals moves and FIG. 5B shows the environment after the group of the user terminals moves.

The position of the mobile AP may be changed according to the concentration of the user terminals that are dynamically changed in a downtown and the interference degree of the adjacent service areas.

As shown in FIG. 5, when the APs are out of the service coverage due to the movement of a user terminal group 520, a mobile AP 510 receives the positional information from the GPS and moves based on the received information so as to provide services to the user terminal group 520.

In this case, the positional information may be positional information of a targeted point to move or a moving point closest to an area in which the user terminals are concentrated. Alternatively, the mobile AP 510 receives the positional information of the user terminal and then, may select the closest area among the previously stored moving point candidates.

Meanwhile, the communication method based on the mobile AP in accordance with the exemplary embodiment of the present invention may be applied to the communication system using a TV white space band.

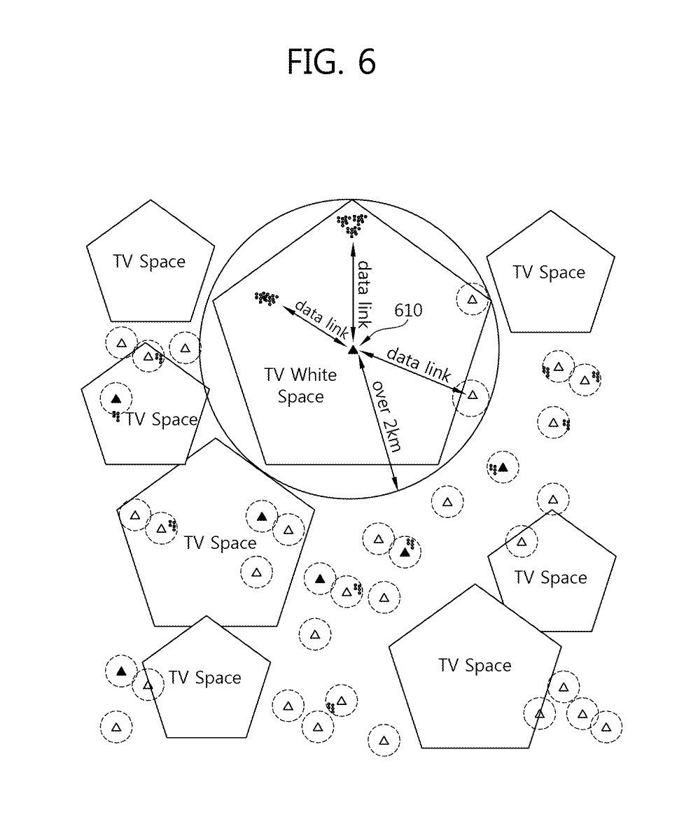

FIG. 6 is a diagram showing an example to which the exemplary embodiment of the present invention is applied in a communication system based on a TV white space band. In FIG. 6, a dark triangle represents the mobile AP and a white triangle represents the fixed AP.

The TV white space means a frequency band defined so as for secondary users recognizing and using an idle frequency to use the corresponding frequency band, when primary users using a relatively low frequency such as a 800 MHz band do not use the corresponding frequency band.

Referring to FIG. 6, a mobile AP 610 provides services to other communication devices within the specific coverage in the TV white space band. The mobile AP 610 moves to an area other than the TV space coverage to provide services.

As shown in FIG. 6, the mobile AP 610 can efficiently control the service area and may be used to extend the service coverage of a super WiFi terminals using the TV white space area, under the condition that a signal arrival distance is secured up to about 2 km in terms of frequency characteristics and the interference does not occur among the adjacent TV space service coverages.

When the mobile AP 610 is used in a military or an area out of a downtown, the TV space area is not substantially present and the communication using the mobile AP may be more easily performed.

To this end, the mobile AP may include a WiFi chipset that interchanges a super WiFi mode with a normal WiFi mode. The normal WiFi mode is a WiFi mode that is interchanged with a WLAN standard such as IEEE 802.11 a/b/g/n/ac, or the like, and the super WiFi mode means a WiFi mode that uses a high transmit output at a low frequency to extend a service area.

The communication method and the radio apparatus in accordance with the exemplary embodiments of the present invention can determine whether the mobile AP moves based on the positional information and the interference information. In addition, if it is determined that the mobile AP moves, the moving position can be determined The mobile AP may determine the moving position using as the positioning conditions the position at which the services can be provided to the STA positioned outside of the conventional service coverage, the position at which the concentration of the STAs can be reduced, and the position at which the overlapping area of the service coverages among the APs can be minimized. The mobile AP includes the moving unit and thus, can automatically move when the movement of the AP or not and the moving position are determined As a result, when the STA such as the mobile communication terminal is out of the coverage due to the movement thereof, the mobile AP can continuously provide services by the movement thereof, the concentration of the STAs can be reduced to improve the throughput of the WLAN, the service coverages among the APs can be controlled to improve the service quality and the efficiency of the wireless medium access.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A communication method based on an access point (AP) in a radio communication system, comprising:
acquiring positional information regarding at least one station (STA) and at least one adjacent AP;
acquiring interference information from the at least one adjacent AP;
determining whether to move based on the positional information and the interference information;
determining a position to move based on the positional information and the interference information when determining to move;
moving to the position to move; and
providing communication services to a subscribed STA at the position.

2. The communication method of claim 1, wherein the step of determining whether to move includes,
determining whether STA positioned outside of current service coverage of the AP is present, and
if it is determined that the STA positioned outside of the current service coverage is present, determining to move.

3. The communication method of claim 2, wherein the position to move is determined so that the STA positioned outside of the current service coverage is positioned within a new service coverage based on the position.

4. The communication method of claim 3, wherein the interference information includes information indicating the service coverage of the at least one adjacent AP.

5. The communication method of claim 4, wherein the position to move is determined so as to minimize an area in which the new service coverage overlaps the service coverage of the at least one adjacent AP based on the position to move.

6. The communication method of claim 5, wherein the positional information is received via a global positioning system (GPS).

7. The communication method of claim 6, wherein the step of moving is performed to move to the position by an unmanned mobile body.

8. The communication method of claim 7, wherein the unmanned mobile body is an unmanned aerial vehicle (UAV).

9. The communication method of claim 1, wherein the communication service provided to the subscribed STA is a wireless local area network (WLAN).

10. A radio apparatus, comprising:
a communication module that transmits and receives radio signals;
a control unit that is operated by being functionally coupled with the communication module; and
a mobile unit that moves when receiving a moving command from the control unit,
wherein the communication module is configured to:
receive positional information regarding at least one station (STA) and at least one adjacent access point (AP), and
receive interference information from the at least one adjacent AP,
the control unit is configured to:
determines whether to move based on the positional information and the interference information,
determines a position to move based on the positional information and the interference information when determining to move, and
transmit a moving command including information regarding the position to move to the mobile unit, and
the mobile unit moves the radio apparatus to the position to move.

11. The radio apparatus of claim 10, wherein the determining whether to move includes,
determining whether STA positioned outside of current service coverage of the radio apparatus is present, and
if it is determined that the STA positioned outside of the current service coverage is present, determining to move.

12. The radio apparatus of claim 11, wherein the position to move is determined so that the STA positioned outside of the current service coverage is positioned within new service coverage based on the position.

13. The radio apparatus of claim 12, wherein the interference information includes information indicating the service coverage of the at least one AP.

14. The radio apparatus of claim 13, wherein the position to move is determined so as to minimize an area in which the new service coverage of the AP overlaps the service coverage of the at least one adjacent AP based on the position to move.

15. The radio apparatus of claim 14, wherein the position information is received via a global positioning system (GPS).

16. The radio apparatus of claim 15, wherein the mobile unit includes:
a moving unit driving unit; and
an automatic navigation device,
wherein the automatic navigation device performs a moving control based on information regarding the position to move, and
the moving unit driving unit moves the radio apparatus according to the moving control.

17. The radio apparatus of claim 16,
wherein the moving unit driving unit includes a moving unit based on an unmanned mobile body, and
wherein the moving to the position to move is performed by the moving unit based on the unmanned mobile body.

18. The radio apparatus of claim 17, wherein the unmanned mobile body is an unmanned aerial vehicle (UAV).

19. The radio apparatus of claim 17, further comprising: an input/output unit,
wherein the input/output unit includes at least one sensor for recognizing external environment of the radio apparatus.

20. The radio apparatus of claim 11, wherein the control unit provides communication services to a subscribed STA at the position to move.

21. The radio apparatus of claim 20, wherein the communication service is a wireless local area network (WLAN).
